(19) United States
(12) Patent Application Publication
(10) Pub. No.: US 2002/0118820 A1
(43) Pub. Date: Aug. 29, 2002

(54) High density digital subscriber line splitter

(76) Inventors: George E. Sinclair III, Belmont, NH (US); Kevin Durkee, Ctr. Barnstead, NH (US); Benjamin Floyd, Northfield, NH (US)

Correspondence Address: Lawson, Philpot, & Persson, P.C., 67 Water Street, Suite 110, Laconia, NH, 03246, US

(21) Appl. No.: 09/794,767

(22) Filed: Feb. 26, 2001

(51) Int. Cl. H04M 1/00; H04M 9/00

(52) U.S. Cl. 379/399.01

(57) ABSTRACT

An electronic assembly and digital subscriber line splitter. The splitter includes a subrack housing, a plurality of splitter port cards, a connector card and an edge card. The splitter port cards each include a plurality of splitter ports and are disposed within the housing between, and in substantially perpendicular relation to, the first side and the second side. The connector card is disposed adjacent, and in substantially parallel relation, to the back of the housing and includes a plurality of external connectors that extend through the openings through the back of the housing. The edge card is disposed in substantially parallel relation to the connector card, includes a plurality of internal connectors disposed in electrical communication with the external connectors of the connector card, and is removably attached to each of the splitter port cards such that each splitter port is in electrical communication with one of the external connectors of the connector card.

### FIELD OF THE INVENTION

The present invention relates to the field of data and voice interchange and, in particular, to a high density asymmetric digital subscriber line splitter.

### BACKGROUND OF THE INVENTION

Asymmetric Digital Subscriber Line (ADSL) is a technology that allows for simultaneous voice and data traffic to coexist over a standard telephone transmission line. Typically, the standard telephone transmission lines connect a central telephone system (a “central” unit) to a subscriber's telephone (a “remote” unit) and can support bandwidths of up to 2 MHz through the use of digital signal processing (DSP) technology. Thus, they can be used for bandwidth-intensive applications, such as Internet access and video-on demand, as well as for carrying voice traffic.

In order for ADSL to function, special equipment is needed at both the customer premises and at the phone company's central office where the customer's copper phone line terminates. ADSL uses high frequencies for data traffic and low frequencies for voice calls and, therefore, the signal received over the copper phone line must be split into high and low frequency components. When data traffic and voice calls are sent to the customer, this splitting operation is performed by a central office splitter, which contains a low-pass filter and a high-pass filter. The low pass filter outputs the low-frequency components, which carry the voice calls, from copper phone line to the standard POTS analog telephone set at the customer premises. The high-pass filter outputs the high-frequency components from the copper phone line to an ADSL modem, from which a computer reads the digital data.

When data is to be sent from the customer to the central office, the computer transmits digital data to the ADSL modem for conversion to analog-voltage modulations. The premises splitter then mixes high-frequency data from ADSL modem with the low-frequency voice from telephone set and transmits the combined signal over copper phone line to the central office. Once received at the central office, the high-frequency components are split by the office splitter. These high-frequency components are then sent to another ADSL modem for converting the analog-voltage high-frequency signal to a digital data stream, which can then be combined with a high-speed data highway or backbone. The low-frequency components are directed to a conventional telephone switch, which is similar to other line cards that terminate POTS lines. This switch connects to other switch circuits to be combined with other calls and sent to a pulse-code-modulated (PCM) highway for transmission to other central offices or to the long distance networks.

ADSL is becoming more and more and popular for high-speed modem applications. The ANSI Ti.413 ADSL standard uses a technology called Discrete Multi-Tone (DMT) that sends data over 255 separate frequency channels, and each 4 kHz frequency channel can be made to provide a bit rate up to the best present day voice band (56 kb/s) modems. This results in overall performance that is substantially equivalent to one hundred V.90 modems used in parallel on the same line. In addition, because each channel can be configured to a different bit rate according to the channel characteristics, DMT is inherently “rate-adaptive” and extremely flexible for interfacing with different subscriber equipment and line conditions. Finally, ADSL can be obtained at a relatively low cost when compared with other means of obtaining similar levels of bandwith.

Due to their inherent advantages, demand for ADSL has risen sharply and, correspondingly, the need to handle large numbers of subscribers has also risen. In fact, the number of DSL lines has been forecasted to grow from 10 million lines in the year 2000 to 90 million in 2004. However, current central office infrastructure is not suited to meet this high demand.

ADSL office splitters are typically housed in sub-racks that fit within standard nineteen or twenty-three inch electronic racks. Each splitter sub-rack typically houses between eight and twenty-four splitter ports, which each connect with a single customer's POTS line. Given the fact that a six sub-racks may be installed in a rack occupying approximately 1.5 square feet of floor space, projected demand would require an increase of approximately 1.7 million square feet of central office space just to house office splitters. Accordingly, there is a need for products that will allow DSL providers to serve larger volumes of customers in a given space.

A number of products have been developed in an attempt address this need. Some of these products have focused upon the processing of the multiple data sets at a single port and directing processed data to a subscriber's phone line. Although these systems allow a provider to serve more subscribers than through the use of dedicated splitters, they do not completely solve the problem as they do nothing to increase the total number of splitters that may be provided at a central office having a fixed amount of space.

Others products have focused upon the miniaturization of the ports themselves, which allows more splitter ports to be located upon each splitter card. These products allow for an increase in the total number of ports that may housed in each sub-rack. However, the number of cards that may be located within each sub-rack has heretofore been limited by the physical connection of each board to the industry standard connectors at the back of the sub-rack. This problem could be solved by utilizing non-standard connectors. However, this solution is unacceptable due to the need for splitters to integrate with existing infrastructure and the increased cost associated with providing adapters to allow the splitters to integrate with such standard 50 pin Amphenol type connectors.

Therefore, there is a need for a product that increases the total number of splitters that may be provided at a central office having a fixed amount of space and is capable of utilizing standard 50 pin Amphenol type connectors.

### SUMMARY OF THE INVENTION

The present invention is a digital subscriber line (hereafter DSL) splitter that increases the total number of splitters that may be provided at a central office having a fixed amount of space. In its most basic form, the DSL splitter includes a subrack housing having a top, a bottom, a first side, a second side, a front, and a back through which a plurality of openings are disposed. A plurality of splitter cards, each of which include a plurality of splitter ports, are provided. Each splitter card is disposed within the housing between, and in substantially perpendicular relation to, the first side and the second side. A connector card is disposed adjacent, and in substantially parallel relation, to the back of the housing. The connector card includes a plurality of external connectors that extend through the openings through the back of the housing. Finally, an edge card is disposed in substantially parallel relation to the connector card. The edge card includes a plurality of internal connectors disposed in electrical communication with the external connectors of the connector card and is removably attached to each of the splitter port cards such that each splitter port is in electrical communication with one of the external connectors of the connector card.

In the preferred embodiment, the external connectors are standard fifty-pin connectors and each of the splitter ports is in electrical communication with three such external connectors. In this arrangement, one of the external connectors provides a DSL connection, another of the external connectors provides a public switched telephone network (hereafter PSTN) connection, and a third of the connectors provides a loop connection.

The preferred splitter includes six splitter port cards, each of which includes twenty-four splitter ports, a stiffening member and at least one combination locking and ejector tab. These six splitter port cards are in electrical communication with eighteen external connectors, of which six provide digital subscriber line connections, six provide public switched telephone network connections, and provide loop connections.

Finally, the subrack housing of the preferred splitter is dimensioned to fit within a standard nineteen or twenty-three inch electronic rack and includes a front cover which is rotatable to allow splitter port cards to be replaced without removing the entire subrack from the electronic rack.

Therefore, it is an aspect of the invention to provide an ADSL splitter that increases that number of splitter ports that may be employed in a single standard size electrical subrack.

It is a further aspect of the invention to provide an ADSL splitter that will mount in a standard nineteen or twenty-three inch electrical rack.

It is further aspect of the invention to provide an ADSL splitter in which the physical interface to the shelf is via standard 50 pin Amphenol type connectors.

It is further aspect of the invention to provide an ADSL splitter that utilizes an intermediate edge card both to isolate the splitter cards from the interface connectors at the rear of the rack and to allow a maximization of interface connectors at the rear of the subrack.

It is further aspect of the invention to provide an ADSL splitter that is modular so as to allow a user to replace a single card within the subrack or replace the entire subrack. when a component failure occurs.

It is further aspect of the invention to provide an ADSL splitter that is ANSI T 1.413-1998 and NEBS Compliant.

It is further aspect of the invention to provide an ADSL splitter that ADSL and POTS coexist by blocking high-frequency ADSL energy from interfering with POTS equipment.

It is further aspect of the invention to provide an ADSL splitter that is a passive device that does not require AC or DC power.

It is further aspect of the invention to provide an ADSL splitter that works over existing non-loaded copper voice grade wiring.

It is further aspect of the invention to provide an ADSL splitter that provides DC blocking to insure against unauthorized access of dial tone.

It is a still further aspect of the invention to provide an ADSL splitter that employs a life-line POTS feature that will not interrupt POTS service even if POTS splitter cards are removed.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is an exploded assembly view of the housing, connector card and edge card of the preferred splitter of the present invention.

FIG. 2 is a back view of the preferred housing of the present invention showing the connector openings.

FIG. 3A is a front view of the preferred connector card.

FIG. 3B is a rear view of the preferred connector card.

FIG. 4A is a rear view of the preferred edge card.

FIG. 4B is a front view of the preferred edge card.

FIG. 5 is a top view of the preferred splitter card.

FIG. 6 is a diagrammatic view showing the circuits making up a single splitter port.

FIG. 7 is an exploded side view showing the connection between the preferred connector card, edge card, and splitter card.

### DETAILED DESCRIPTION OF THE INVENTION

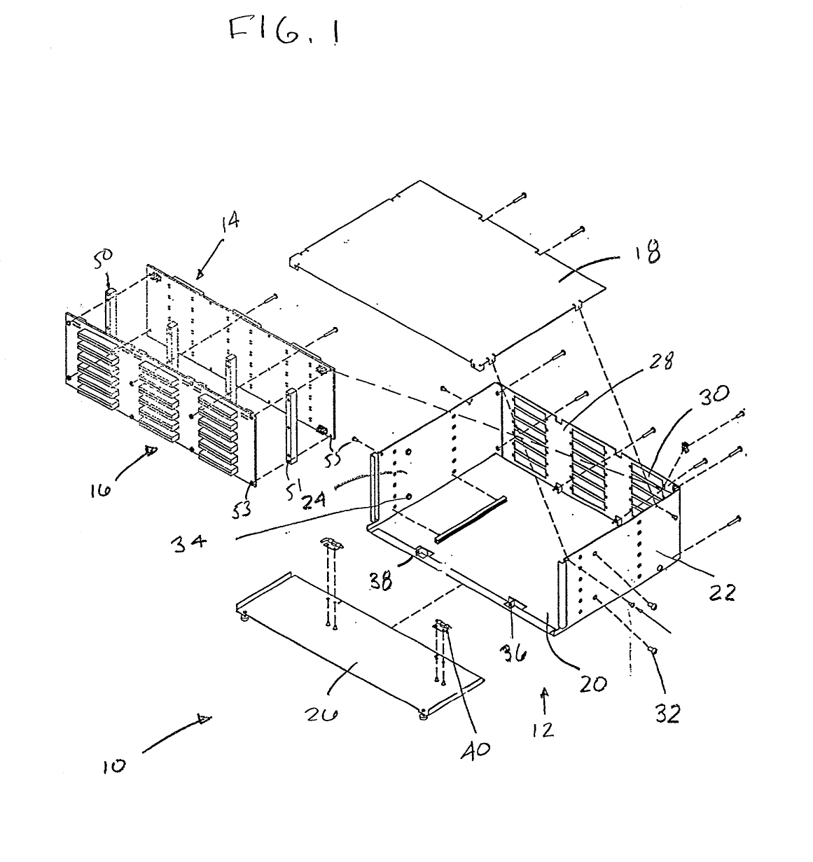

Referring first to FIG. 1, an exploded assembly view of the subrack housing 12, connector card 14, and edge card 16 of the preferred DSL splitter 10 is shown. The subrack housing 12 includes a top 18, a bottom 20, a first side 22, a second side 24, a front 26, and a back 28 through which a plurality of openings 30 are disposed.

The preferred subrack housing 12 is a substantially hollow rectangular prism that is dimensioned to fit within a standard nineteen or twenty-three inch electronic rack (not shown). Accordingly, the preferred sides 22, 24 are approximately five and one-quarter inches in height nine and three-quarter inches in length, and the top 18 and bottom 20 are approximately sixteen inches in width. In the preferred embodiment, the subrack housing 12 is adapted to be secured with both nineteen or twenty-three-inch electronic rack via a pair of mounting adapters (not shown) that include two sets of mounting holes, with each set of holes corresponding to either a nineteen inch or twenty-three inch rack. The preferred mounting adapters may be flipped over to change the orientation of the holes. However, it is recognized that other art recognized means may be utilized for adapting the subrack housing to fit within standard electronic housings.

The preferred subrack housing 12 is manufactured of sheet metal and is assembled using machine screws 32 and self clinching nuts 34, such as those manufactured by the Penn Engineering & Manufacturing Corp.. However, other embodiments are assembled using other art recognized fasteners, such as sheet metal screws, machine screws and lock nuts, clips, or the like, while others are joined by welding, brazing or soldering.

In some alternative embodiments, the subrack housing 12 is manufactured of plastic, resins, composites or the like. In some such embodiments, the subrack housing 12 is formed as a two piece structure in which the front 26 is one piece and the top 18, bottom 20, back 28 and sides 22, 24 are a unitary structure. In others, the top 18, bottom 20, back 28, and sides 22, 24 are formed as two pieces and are assembled in a “clam shell” orientation. In still others, each of the front 26, top 18, bottom 20, back 28 and sides 22, 24 are formed separately and assembled in the same manner as described above with reference to the sheet metal embodiments. It is recognized that, in order to be used in the United States, subrack housings 12 manufactured of non-metal materials must allow for a safety ground and allow the subrack housing 12 to meet the NEBS GR63 flame spread standard. Accordingly, the use of plastics and other non-conducting and/or flammable materials is not preferred.

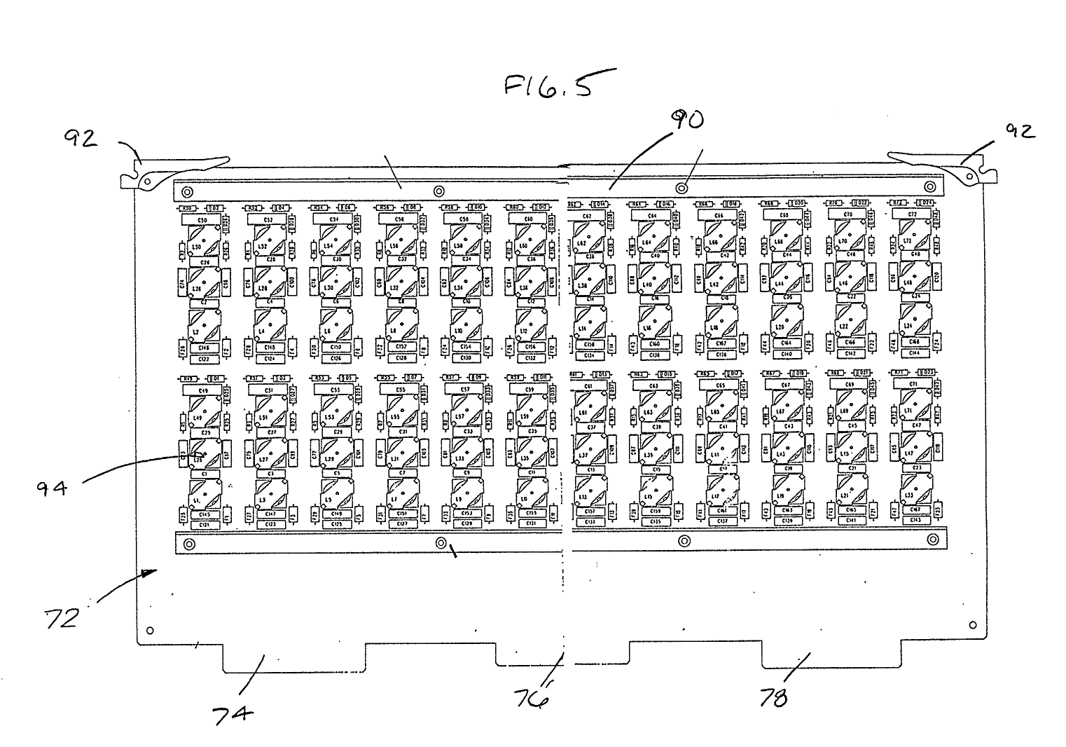

The preferred subrack housing 12 includes a rotatable front 26, which allows hollow interior of the housing 12 to be accessed. This allows splitter port cards, such as those shown in FIG. 5, to be replaced without removing the entire subrack housing 12 from its electronic rack (not shown). In order to provide the front 26 with the desired rotation, the preferred bottom 20 includes a pair of door pivots 36 along its front edge 38 and the front 26 includes a pair of latches 40 that include pins 42 are dimensioned to mate with the door pivots 36. These latches 40 allow the front 26 to pivot and 26 to be completely removed from the subrack housing 12 through disengagement of the latches 40.

Although the preferred subrack housing 12 utilizes door pivots 36 and latches 40, in other embodiments the front 26 rotates about one or more fixed hinges (not shown). In others, the front 26 is not rotatable, but is removably attached to the remainder of the housing via fasteners, such as machine screws, magnets, clips, or other art recognized fasteners.

As shown in FIG. 1, the connector card 14 and edge card 16 of the preferred DSL splitter 10 are held a fixed distance apart from one another via a plurality of spacers 50. These spacers are preferably manufactured of a phenolic material and include a plurality of holes 51 that are dimensioned and disposed to allow screws to pass through the spacers 50 and holes 53, 55 in the edge card 16 and connector card 14 to secure the connector card 14 and edge card 16 together. Although the preferred spacers are manufactured of a phenolic material, it is recognized that spacers 50 manufactured of other non-conductive materials may be utilized to achieve similar results. Further, the preferred spacers 50 are solid, substantially rectangular prisms, which provide additional rigidity to the assembly. However, it is recognized that spacers 50 having other dimensions, or multiple spacers 50 made up of non-conductive screw stand-offs (not shown), may be substituted to achieve similar results.

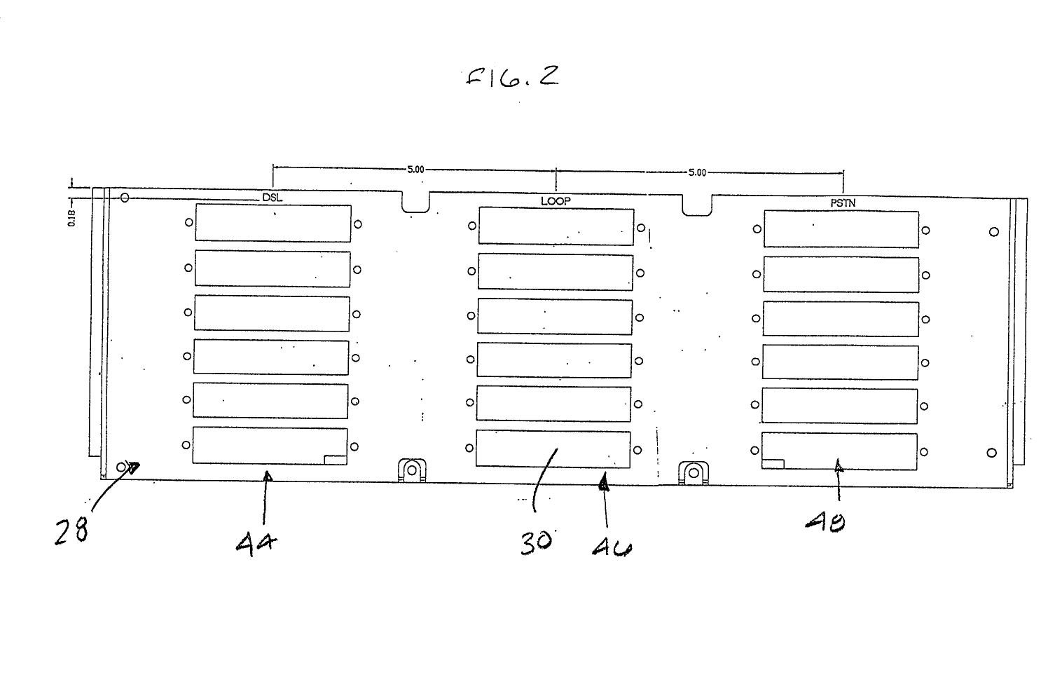

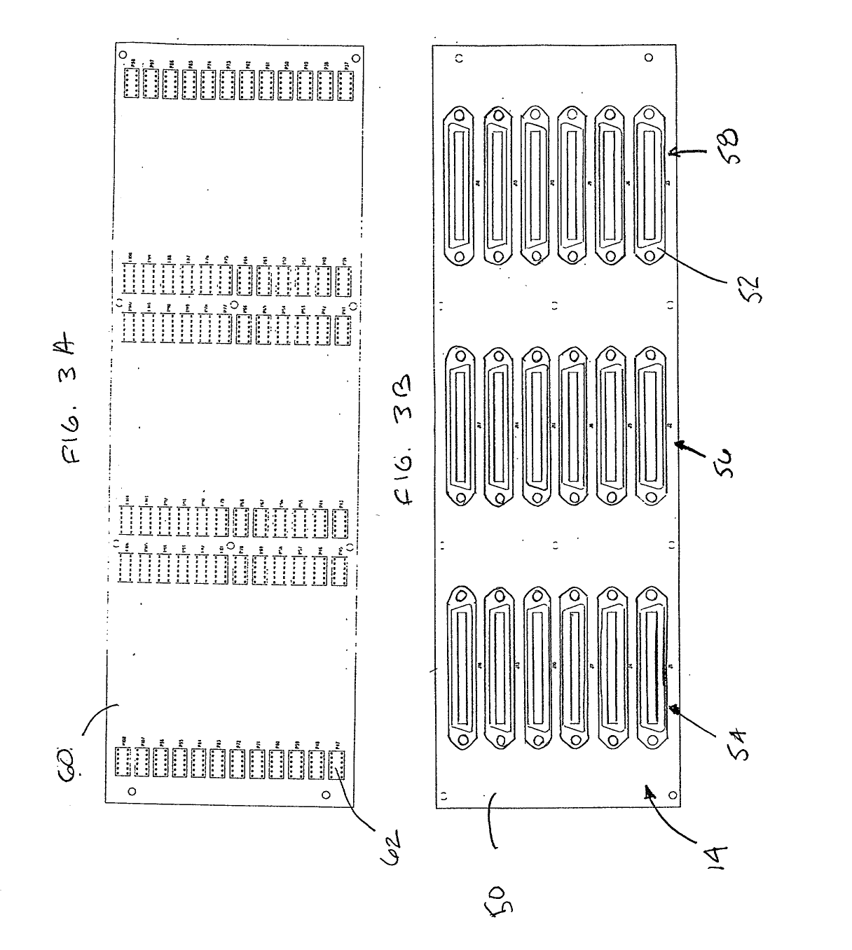

Referring now to FIGS. 2 and 3B the back 28 of the preferred subrack housing 12 is shown. As noted above, a plurality of openings 30 are disposed through the back 28 and are dimensioned to accept the external connectors 52, which extend from the back side 50 of the connector card 14. The preferred back 28 includes eighteen openings 30, which are divided into three columns 44, 46, 48. These correspond to three columns 54, 56, 58 of connectors 52 on the connector card 14. The first column 54 on the connector card 14 includes six connectors that provide DSL connections, the second column 56 includes six connectors that provide loop connections, and the third column 58 includes six connectors that provide PSTN connections.

The connector card 14 is disposed adjacent, and in substantially parallel relation, to the back 16 of the subrack housing 12. The connector card 14 includes a back side 50 from which the external connectors 52 extend. The external connectors 30 are aligned with, and pass through, the openings 30 through the back 28 of the housing 12. In the preferred embodiment, the external connectors 52 are standard female 50 pin Amphenol type Telco connectors, such as those sold by A.W. Industries under Part No. 8550 F-02-52P or Tyco Electronics under Part No. 553443-4.

In the preferred embodiment, the external connectors 52 in the first and second columns 54, 56 are oriented such that the mating male left-angled cable head (not shown) will dress out to the left side of the shelf, while the external connectors 52 in third column 58 are oriented such that the mating male right-angled cable head (not shown) will dress out to the right side of the shelf. However, it is recognized that other orientations and/or art recognized connectors may be substituted to achieve similar results.

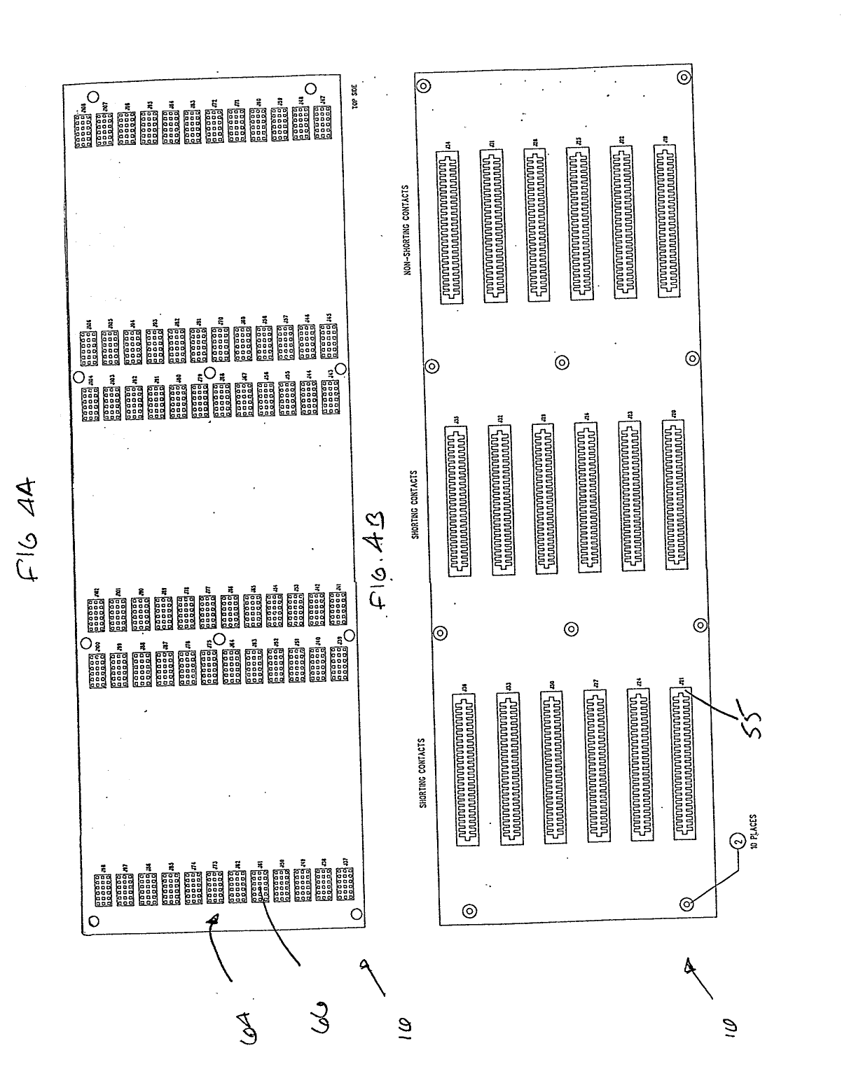

Referring to FIGS. 3A and 4A, the front 60 of the connector card 14 includes a plurality of header strips 62 disposed at predetermined locations corresponding to the locations of the socket strips 66 on the back side 64 of the edge card 16. In the preferred embodiment, seventy-two header strips 62 are provided, with each being of the twelve position type, such as those sold by Maxtech Co., LTD under Part No. LPHB3-18 S-020-6/5, or those sold by Samtec under Part No. TSW-106-08-G-Q. These header strips 62 soldered to the connector card 14 and are electrically connected to the external connectors 52 via traces within the card 14. Likewise, seventy-two socket strips 66 are provided, with each also being of the twelve position type, such as those sold by Maxtech Co., LTD under Part No. PHF3-18 S-20-6.0, or those sold by Samtec under Part No. SSW-106-22-G-Q.

Referring now to FIGS. 4B and 5, the front 68 of the edge card 16 includes a plurality of edge connectors 70 that are positioned and dimensioned to accept the connection tabs 74, 76, 78 on each splitter card 72. In the preferred embodiment, the edge connectors 70 are disposed in three columns 80, 82, 84. The first and second columns 80, 82 of edge connectors 70 have shorting contacts and are of the type sold by A.W. Industries under Part. No. 2225L -11-54-333, or by ESC under Part No. 1025-N1-30-630. The third column 84 of edge connectors 70 have non-shorting contacts and are of the type sold by A.W. Industries under Part. No. 2225L -11-52, ECS under Part No. 1025-N1-11-30, or EDAC, Inc. under Part No. 725-050-520-201.

Each splitter card 72 is disposed horizontally within the subrack housing 12 between, and in substantially perpendicular relation to, the first side 22 and the second side 24. In the preferred embodiment, each splitter card 72 includes a stiffening member 90 disposed along the top surface of the card 72. This stiffening member 90 provides additional support for the card 72 and acts to reduce the risk of damage to the card 72 due to flexure. The preferred splitter card 72 also includes and at least one combination locking and ejector tab 92. These tabs 92 allow the splitter card 72 to be easily locked into place during use while allowing the card 72 to be easily removed and replaced. In the preferred embodiment, this card ejector is of the type sold by Bivar, Inc. under Part No. 11073-062. However, other embodiments may utilize similar locking and ejector tabs 92.

The splitter card 72 includes a plurality of splitter ports 86, which are in electrical communication with the connection tabs 74, 76, 78 at the edge of each splitter card 72. In the preferred embodiment, each splitter card includes twenty-four splitter ports 86. These splitter ports 86 preferably have a low profile above the surface of the board sufficient to allow six splitter cards 72 to be disposed within the subrack housing 12.

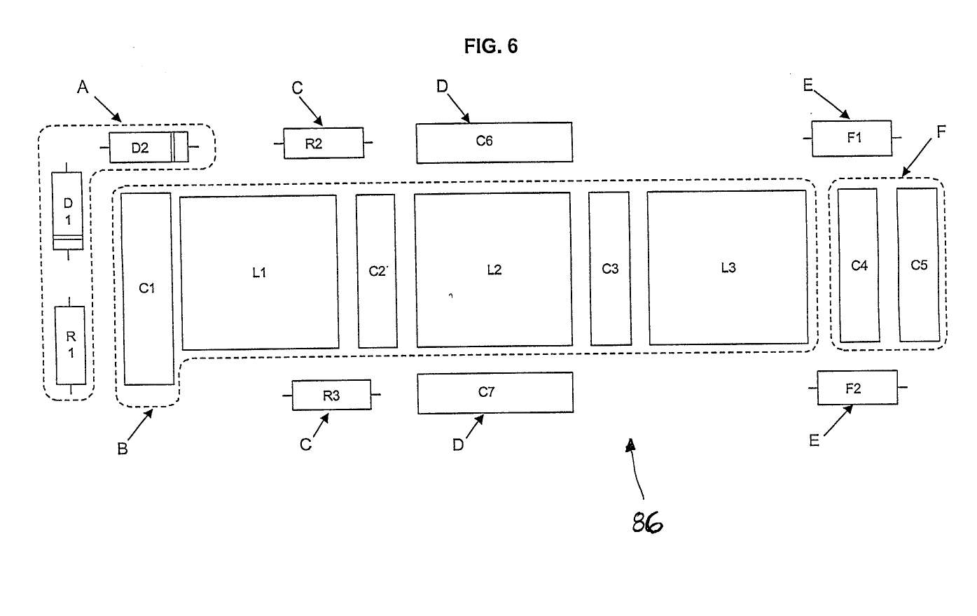

As shown in FIG. 6, in the preferred embodiment, each splitter port 86 includes six circuits A-F, each made up of one or more individual components. The first of these circuits is the signature circuit A made up of a zener diode D1, preferably of a 36.0 v 5% 1 W 1N4753 type, a rectifier diode D2, preferably of a 1000 v 1 A 1N4007 type, and a metal film resistor R1, preferably a ¼ W 1% 33.2 k ohm resistor. The signature circuit is described in ANSI T1.414-1998 Annex E, section E. 1.7, and allows mechanized loop testing (MLT) apparatus to detect the presence of the DSL Splitter on the telephone circuit.

The second circuit is a 6-pole elliptic low-pass filter circuit B. The preferred low pass filter circuit B is made up of three inductors L1, L2, L3, LI preferably being a bifilar-wound 15.1 mH inductor and L2, L3 being bifilar-wound, 16.9 mH inductors, and three capacitors C1, C2, C3, preferably metalized polyester, 400 V 5% capacitors at 0.047 uF, 0.027 uF, and 0.01 uF, respectively. The low-pass filter circuit B preferably has a corner frequency of approximately 7 kHz, a pass band ripple of less than 0.2 dB, input impedance of approximately 900 ohms and an output impedance of approximately 600 ohms.

The third circuit is a high frequency bypass circuit C to increase high-band Structural Return-Loss (SRL-HI) of the low-pass filter. The preferred high frequency bypass circuit C is made up of a pair of resistors R1, R2, each preferably being of a metal film ¼ W 1% 249 ohm type.

The fourth circuit is a resonant tank circuit D to increase the roll-off characteristics in the stop-band of the low-pass filter. The preferred resonant tank circuit D preferably has a fundamental frequency at 30 kHz and is made up of a pair of capacitors, C6, C7, each preferably being a metalized polyester 630 V 5% 0.0039 uF capacitor.

The fifth circuit is an over current protection circuit E, which is a required circuit for UL 1950 recognition. This circuit is preferably made up of a pair of fast acting fuses F1, F2 preferably rated at 500 mA.

The final circuit is a single-order high-pass filter circuit F between LINE and DSL connections. This single-order high-pass filter circuit F acts as a DC blocking circuit preventing DC current from flowing from the LINE interface to the ADSL interface. The intended purpose is to prevent unauthorized access to dial tone from the DSL interface. In the preferred embodiment, this circuit F is made up of a pair of capacitors C4, C5, which are preferably metalized polyester 100 V 5% 0.12 uF capacitors.

It is noted that the circuits and layout of the splitter port 86 are the preferred circuits and layout and that other variations of the splitter port 86 will be readily apparent to those of ordinary skill in the art. Further, it is understood that the advantages attendant to the mechanical layout of the present invention will have applicability beyond the field of DSL splitters and, therefore, the present invention should not be seen as being limited to this preferred application of the layout.

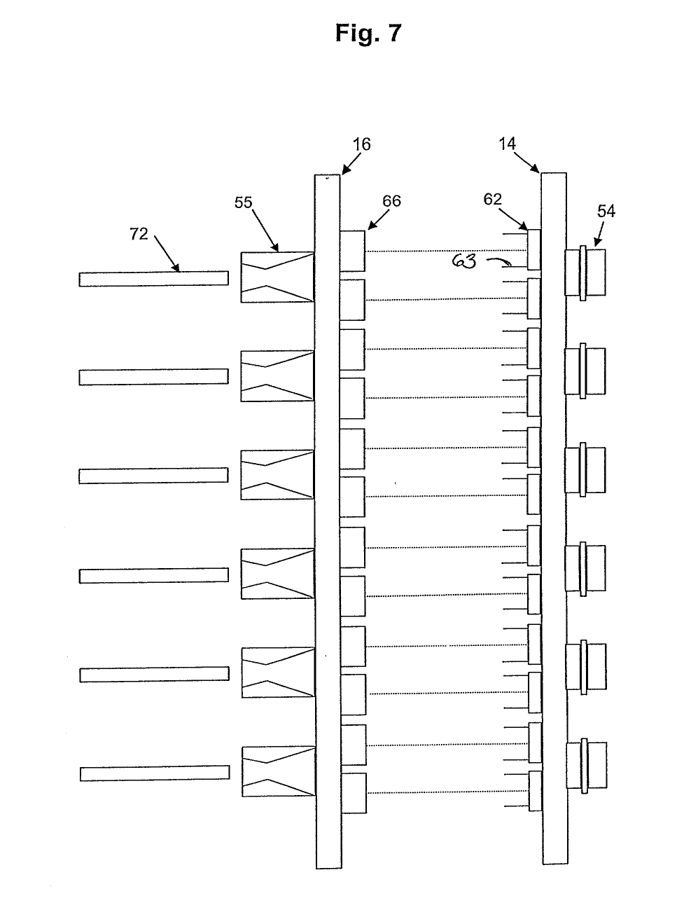

Referring now to FIG. 7, a cut away view of the connections between the splitter 72, edge card 16 and connector card 14 is shown. As described above, the edge card 16 and connector card 14 are disposed in parallel relation and are placed into electrical communication via the socket strips 66, attached to the back of the edge card 16, and the header strips 62 attached to the front of the connector card 14.

In the preferred embodiment, the header strips 62 include substantially rigid metal pins 63 that extend toward, and are oriented to mate with, the socket strips 66 of the edge card 16. This is preferred as it simplifies the alignment of pins 63 with the correct mating openings of the socket strips 66. However, it is recognized that other art recognized connection means, such a flexible wires, “zebra” type strips, or the like may also be utilized to achieve similar results.

The connection tabs 74, 76, 78 (shown in FIG. 5) at the edge of each splitter card 72 are inserted into the mating connectors 55 of the edge card 16 to place the splitter cards in electrical communication with the edge card 16, connector card 14 and ultimately with the external connectors 52 extending through the back of the subrack housing 12. As shown in FIG. 7, the preferred embodiment includes six splitter cards 72, and was designed to occupy three shelves within the rack. However, other embodiments are designed to fit within a single shelf and include two splitter cards 72, while others utilize a variety of multiples of two splitter cards 72 to fill the desired number of rack shelves.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A digital subscriber line splitter comprising:
a subrack housing comprising a top, a bottom, a first side, a second side, a front, and a back through which a plurality of openings are disposed;
at least two splitter cards disposed within said housing between, and in substantially perpendicular relation to, said first side and said second side, wherein each of said splitter port cards comprises a plurality of splitter ports;
a connector card disposed adjacent, and in substantially parallel relation, to said back of said housing, said connector card comprising a plurality of external connectors that extend through said plurality of openings through said back of said housing; and
an edge card disposed in substantially parallel relation to said connector card, wherein said edge card comprises a plurality of internal connectors disposed in electrical communication with said external connectors of said connector card, and wherein said edge card is removably attached to each of said splitter cards such that each splitter port is in electrical communication with one of said external connectors of said connector card.

2. The digital subscriber line splitter as claimed in claim 1, wherein at least one of said external connectors is a fifty-pin connector.

3. The digital subscriber line splitter as claimed in claim 1, wherein each of said external connectors provides a connection of a type selected from a group consisting of a digital subscriber line connection, a public switched telephone network connection, and a loop connection.

4. The digital subscriber line splitter as claimed in claim 3 wherein each of said splitter ports is in electrical communication with three external connectors, wherein one of said external connectors provides a digital subscriber line connection, another of said external connectors provides a public switched telephone network connection, and a third of said connectors provides a loop connection

5. The digital subscriber line splitter as claimed in claim 1 comprising six splitter cards.

6. The digital subscriber line splitter as claimed in claim 5 wherein each of said splitter cards comprises twenty-four splitter ports.

7. The digital subscriber line splitter as claimed in claim 6 comprising eighteen external connectors, wherein six of said external connectors provide digital subscriber line connections, two of said external connectors provide public switched telephone network connection, and six of said connectors provides a loop connection.

8. The digital subscriber line splitter as claimed in claim 1 comprising two splitter cards.

9. The digital subscriber line splitter as claimed in claim 8 wherein each of said splitter cards comprises twenty-four splitter ports.

10. The digital subscriber line splitter as claimed in claim 9 comprising six external connectors, wherein two of said external connectors provide digital subscriber line connections, two of said external connectors provide public switched telephone network connection, and two of said connectors provides a loop connection.

11. The digital subscriber line splitter as claimed in claim 1 wherein each of said splitter cards further comprises a stiffening member.

12. The digital subscriber line splitter as claimed in claim 11 wherein each of said splitter cards further comprises a combination locking and ejector tab.

13. The digital subscriber line splitter as claimed in claim 1 wherein said subrack housing is dimensioned to fit within an electronic rack chosen from a group consisting of a nineteen inch rack and a twenty three inch rack.

14. The digital subscriber line splitter as claimed in claim 1 wherein said front of said subrack housing is a removable front cover and wherein said housing is dimensioned allows splitter cards to be replaced when said front cover is removed.

15. The digital subscriber line splitter as claimed in claim 1 wherein said front of said subrack housing is a rotatable front cover and wherein said housing is dimensioned allows splitter cards to be replaced when said front cover is rotated.

16. The digital subscriber line splitter as claimed in claim 1 wherein each of said splitter ports comprises a signature circuit, a low pass filter circuit, a high frequency bypass circuit, a resonant tank circuit, an over current protection circuit, and a single-order high-pass filter circuit.

17. The digital subscriber line splitter as claimed in claim 1 wherein said connector card comprises a plurality of header strips and said edge card comprises a plurality of socket strips, and wherein said header strips and said socket strips are dimensioned to mate together to place said edge card into electrical communication with said connector card.

18. An electronic assembly comprising
a subrack housing comprising a top, a bottom, a first side, a second side, a front, and a back through which a plurality of openings are disposed;
at least two circuit cards disposed within said housing between, and in substantially perpendicular relation to, said first side and said second side, each of said circuit cards comprising a plurality of circuits;
a connector card disposed adjacent, and in substantially parallel relation, to said back of said housing, said connector card comprising a plurality of external connectors that extend through said plurality of openings through said back of said housing; and
an edge card disposed in substantially parallel relation to said connector card, wherein said edge card comprises a plurality of internal connectors disposed in electrical communication with said external connectors of said connector card, and wherein said edge card is removably attached to each of said circuit cards such that each circuit is in electrical communication with one of said external connectors of said connector card.

19. The electronic assembly as claimed in claim 18 wherein said connector card comprises a plurality of header strips and said edge card comprises a plurality of socket strips, and wherein said header strips and said socket strips are dimensioned to mate together to place said edge card into electrical communication with said connector card.

20. The electronic assembly as claimed in claim 18 wherein said edge card is attached to said connector card by at least one nonconductive spacer.
